(19) United States
(12) Patent Application Publication
(10) Pub. No.: US 2022/0198012 A1
(43) Pub. Date: Jun. 23, 2022

(54) Method and System for Security Management on a Mobile Storage Device

(71) Applicant: Siemens Aktiengesellschaft, München (DE)

(72) Inventors: Dai Fei Guo, Beijing, Hia Dian District (CN); Wen Tang, Beijing (CN)

(73) Assignee: Siemens Aktiengesellschaft, München (DE)

(21) Appl. No.: 17/637,389

(22) PCT Filed: Aug. 23, 2019
(86) PCT No.: PCT/CN2019/102329

§ 371 Date: Feb. 22, 2022

(51) Int. Cl. G06F 21/56; G06F 21/55; G06F 21/78

(52) U.S. Cl. CPC G06F 21/565; G06F 21/78; G06F 21/552; G06F 21/564

(57) ABSTRACT

Various embodiments include a method for security management at a scanning system installed outside a monitored system. The method comprises: acquiring first information for identification of a mobile storage device; generating third information to indicate current status of files on the mobile storage device; and sending the first information and the third information to a monitoring system to check if usage of the mobile storage device in the monitored system is secure.

### CROSS-REFERENCE TO RELATED APPLICATIONS

This application is a U.S. National Stage Application of International Application No. PCT/CN2019/102329 filed Aug. 23, 2019, which designates the United States of America. The contents of which is hereby incorporated by reference in their entirety.

### TECHNICAL FIELD

The present disclosure relates to security management. Various embodiments may include methods, apparatuses, systems and/or computer-readable storage media for security management of a mobile storage device.

### BACKGROUND

In an industrial control network (also known as an Operation Technology (OT) system), more and more field devices are attacked by malware. Although an industrial control system is usually isolated from internet and IT network by physical or logical security measures, a mobile storage device and/or possible data exchanging caused by the mobile storage device can pose great threat to an industrial control system. Malware may infect an industrial control system via the mobile storage when it is used in an industrial system.

Some methods or systems for security management on a mobile storage device have been proposed to control usage of a mobile storage device in an industrial control system. A Universal Serial Bus (USB) control software can be used to limit usage of a mobile storage device such that the processed mobile storage device can be used in a target system, but a software must be installed in the target system which controls external interface usage and the mobile storage device will be checked and it will be determined whether the mobile storage device can be used in the target system. This may cause the compatibility problem and degrade the performance of the target system. In some scenarios, it may even affect normal running of the industrial control device.

Furthermore, in some industrial control processes, a mobile storage device is required to be conducted of a malware scanning on a dedicated host before it is connected to an industrial control device, but it is difficult to be checked whether the mobile storage device has been scanned before it is used in the industrial control system. In many scenarios, an operator or engineer may not conduct scanning due to shortage of security awareness or they use any mobile storage directly in an industrial control system when carrying out some urgent tasks. It will cause great threat and it is not easy to detect such violation behaviors.

### SUMMARY

Various embodiments of the teachings herein may be used for security management on a mobile storage device in a monitored system, status identification based mobile storage device scanning and detection is executed to detect the security status of a mobile storage by combining malware scanning and the status checking of the mobile storage device. For example, some embodiments include a system for security management on usage of a mobile storage device in a monitored system comprising: a scanning system installed outside the monitored system, a monitoring system installed outside the monitored system, and an information collecting module. The scanning system is configured to: acquire first information for identification of the mobile storage device and generate third information to indicate current status of files on the mobile storage device and send the first information and the third information to the monitoring system; the monitoring system is configured to: receive the first information and the third information from the scanning system; store the first information and the third information correlatively; the information collecting module is configured to: detect the mobile storage device's usage in a monitored system; get fourth information for identification of the mobile storage device and fifth information to indicate current status of files on the mobile storage device; send the fourth information and the fifth information to the monitoring system. The monitoring system is further configured to: receive the fourth information and the fifth information from the information collecting module; use the fourth information to identify the mobile storage device; compare the fourth information and stored first information, to determine whether the mobile storage device has been recorded; if recorded, get the correlatively stored third information and compare the third information and the fifth information, to determine whether the two statuses indicated respectively by the third information and the fifth information are the same; if the two statuses are the same, determine that the usage of the mobile storage device in the monitored system is secure.

As another example, some embodiments include a method for security management at a scanning system installed outside a monitored system including: acquiring, first information for identification of a mobile storage device; generating, third information to indicate current status of files on the mobile storage device; sending the first information and the third information to a monitoring system, for the monitoring system to check if usage of the mobile storage device in the monitored system is secure.

As another example, some embodiments include a method for security management at a monitoring system installed outside a monitored system including: receiving, from a scanning system, first information for identification of a mobile storage device and third information to indicate current status of files on the mobile storage device; storing, the first information and the third information correlatively; receiving, from an information collecting module, fourth information) for identification of the mobile storage device and fifth information to indicate current status of files on the mobile storage device; comparing, the fourth information and stored first information, to determine whether the mobile storage device has been recorded; if recorded, getting the correlatively stored third information; comparing the third information and the fifth information to determine whether the two statuses indicated respectively by the third information and the fifth information are the same; if the two statuses are the same, determining that the usage of the mobile storage device in the monitored system is secure.

As another example, some embodiments include a method for security management at an information collecting module including: detecting, a mobile storage device's usage in a monitored system; getting fourth information for identification of the mobile storage device and fifth information to indicate current status of files on the mobile storage device; sending the fourth information and the fifth information to the monitoring system, for the monitoring system to check if usage of the mobile storage device in a monitored system is secure.

As another example, some embodiments include a scanning system installed outside a monitored system comprising: an acquisition module configured to acquire first information for identification of a mobile storage device; a generation module configured to generate third information to indicate current status of files on the mobile storage device; a sending module configured to send the first information and the third information to a monitoring system, for the monitoring system to check if usage of the mobile storage device in the monitored system is secure.

As another example, some embodiments include a monitoring system installed outside a monitored system comprising: a receiving module configured to receive from a scanning system first information for identification of a mobile storage device and third information to indicate current status of files on the mobile storage device; a processing module configured to store the first information and the third information correlatively; the receiving module further configured to receive from an information collecting module fourth information for identification of the mobile storage device and fifth information to indicate current status of files on the mobile storage device; the processing module further configured to compare the fourth information and stored first information, to determine whether the mobile storage device has been recorded; if recorded, get the correlatively stored third information; compare the third information and the fifth information to determine whether the two statuses indicated respectively by the third information and the fifth information are the same; if the two statuses are the same, determine that the usage of the mobile storage device in the monitored system is secure.

As another example, some embodiments include an information collecting module comprising: a detecting module configured to detect a mobile storage device's usage in a monitored system; a processing module configured to get fourth information for identification of the mobile storage device and fifth information to indicate current status of files on the mobile storage device; a sending module configured to send the fourth information and the fifth information to the monitoring system, for the monitoring system to check if usage of the mobile storage device in a monitored system is secure.

As another example, some embodiments include a scanning system installed outside a monitored system comprising: at least one memory, configured to store instructions; at least one processor, coupled to the at least one memory, and upon execution of the executable instructions, configured to execute method as described herein.

As another example, some embodiments include a monitoring system installed outside a monitored system comprising: at least one memory configured to store executable instructions; at least one processor, coupled to the at least one memory and upon execution of the executable instructions, configured to execute a method as described herein.

As another example, some embodiments include an information collecting module comprising: at least one memory configured to store executable instructions; at least one processor coupled to the at least one memory and upon execution of the executable instructions configured to execute a method as described herein.

As another example, some embodiments include a computer-readable medium, storing executable instructions, which upon execution by a computer, enables the computer to execute the methods as described herein.

### BRIEF DESCRIPTION OF THE DRAWINGS

The above-mentioned attributes and other features and advantages of the present technique and the manner of attaining them will become more apparent and the present technique itself will be better understood by reference to the following description of embodiments of the teachings of the present disclosure taken in conjunction with the accompanying drawings, wherein:

FIG. 1 depicts a system for security management incorporating teachings of the present disclosure.

FIG. 2˜5 depicts flow charts for methods of security management incorporating teachings of the present disclosure.

FIG. 6˜11 depicts block diagrams displaying exemplary embodiments of systems for security management incorporating teachings of the present disclosure.

### DETAILED DESCRIPTION

With the teachings of the present disclosure, a scanning system can send information of the status of files on the mobile storage device at time of scanning to a monitoring system, and an information collecting module can also send information of status of files on the mobile storage device at time of detecting usage of the mobile storage device in a monitored system to the monitoring system. The monitoring system then can determine whether files on the mobile storage device are changed after scanning, to make sure of secure usage of the mobile storage device in the monitored system. With both the scanning system and the monitoring system installed outside the monitored system, possibility of information of the status of files on the mobile storage device being tampered with by attacks towards the monitored system. With cooperation of the mobile system and the information collecting module, usage of the mobile storage device in the monitored system can be detected in the first place, viruses can be isolated before affecting the monitored system. On the other hand, if the files in the scanned mobile storage are changed or infected virus, this system can detect this kind of malicious attack behavior.

In some embodiments, the scanning system can also conduct a malware scanning on the mobile storage device and generate second information to describe security status of the mobile storage device.

In some embodiments, the scanning system can send the second information to the monitoring system, and the monitoring system receives the second information from the scanning system, determine based on the second information whether the mobile storage device can be trusted; if the mobile storage device can be trusted, store correlatively the first information and the third information.

In some embodiments, only if the second information indicates that the mobile storage device can be trusted, the scanning system sends the first information and the third information to the monitoring system. And when informed by the information collecting module of the usage of the mobile storage device in the monitored system, the monitoring system can determine that the usage of the mobile storage device in the monitored system is insecure if the mobile storage device hasn't been recorded.

In some embodiments, security status information of the mobile storage can be sent to the monitoring system, to make sure that the mobile storage device has been cleaned before it can be used in the monitored system. Furthermore, the scanning system is installed in the monitored system is employed, which makes it easy to update malware definition and it can scan the mobile storage with the latest character of malware. It is helpful to detect the latest malware. The solution combines security monitoring and malware scanning system which can clean the malware in the mobile storage device and check violation behaviors that use of a mobile storage device without scanning or use it in an insecure environment before it is used in the monitored system.

In some embodiments, the monitoring system can generate sixth information to indicate whether the usage of the mobile storage device in the monitored system is secure; and send the sixth information to the information collecting module; after receiving the sixth information the information collecting module can isolate the mobile storage device from the monitored system if the sixth information indicates that usage of the mobile storage device in the monitored system in insecure. Once detecting that the mobile storage device's usage in the monitored system is insecure, the mobile storage device can be isolated from the monitored system.

In some embodiments, when generating the third information, the scanning system can make computation based on predefined at least one file and/or at least one area of the mobile storage device and take the computation result as the third information; and when getting the fifth information the information collecting module can generate the fifth information in the same way that the third information is calculated. So the monitoring system can determine that the two statuses are the same if the two calculation result indicated respectively by the third information and the fifth information are the same. The monitoring system can easily make determination by comparing the calculation results. Optionally, the calculation can be a one way hash algorithm which checks integrity of predefined files (such as critical areas) on the mobile storage device.

In some embodiments, when generating the third information the scanning system can record time of scanning the mobile storage device as the third information; when getting the fifth information the information collecting module can record time of detecting the mobile storage device to be connected to a device in the monitored system as fifth information; so the monitoring system can make following judgements: if duration between the two times indicated respectively by the third information and the fifth information is not longer than a predefined threshold, the two statuses are the same; otherwise, the two statuses are different. Such embodiments may provide an easier way to estimate possibility of tampering with files on a mobile storage device, in comparison with calculation on files, this solution can cost less time and calculating resources.

In some embodiments, the scanning system is connected to internet, and there is a security gateway between the scanning system and the monitoring system. The security gateway can be used to control information transmitted from the scanning system to the monitoring system to mitigate risks for the monitoring system.

### DETAILED DESCRIPTION

Hereinafter, above-mentioned and other features of the present disclosure are described in details. Various embodiments are described with reference to the drawings, where like reference numerals are used to refer to like elements throughout. In the following description, for purpose of explanation, numerous specific details are set forth in order to provide a thorough understanding of one or more embodiments. It may be noted that the illustrated embodiments are intended to explain, and not to limit the scope of the disclosure. It may be evident that such embodiments may be practiced without these specific details.

When introducing elements of various embodiments of the present disclosure, the articles “a”, “an”, “the” and “said” are intended to mean that there are one or more of the elements. The terms “comprising”, “including” and “having” are intended to be inclusive and mean that there may be additional elements other than the listed elements.

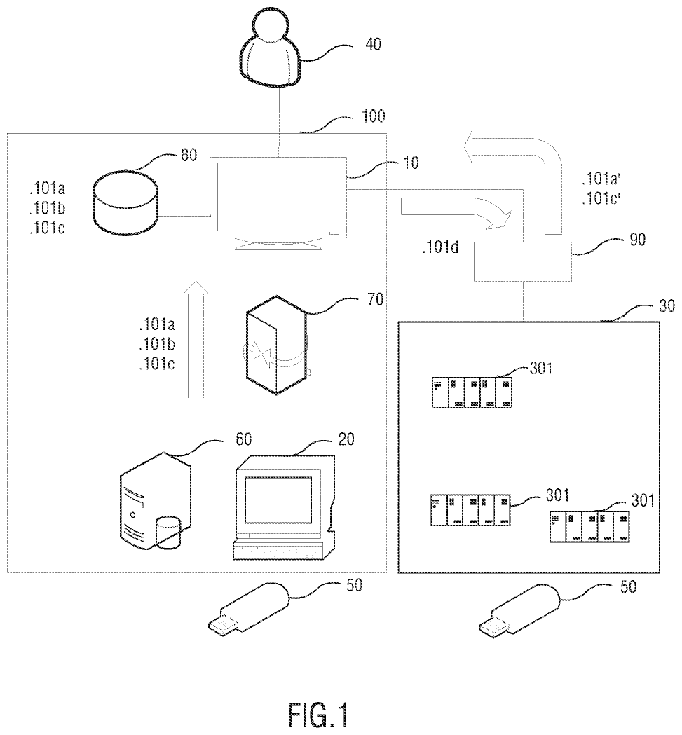

FIG. 1 depicts a system 100 for security management incorporating teachings of the present disclosure. The system 100 can include: a monitoring system 10; a scanning system 20; and an information collecting module 90

The scanning system 20 can be a computer, software installed on a computer, a computer network, etc. A mobile storage device 50 can be malware scanned by the scanning system 20. A mobile storage device 50 may be connected to a device 301 in the monitored system 30. The scanning system 20 can get following information of a mobile storage device 50:
first information 101a, for identification of a mobile storage device 50, which can include but not limited to any or any combination of following items of the mobile storage device 50: (1) hardware fingerprint information; (2) hardware ID; (3) Vendor information; (4) device type and/or size of storage; (5) device name; and (6) other information which can be used for identification of the mobile storage device 50.
second information 101b, generated by the scanning system 20 during malware scanning of a mobile storage device 50, to describe security status of the mobile storage device 50. The second information 101b can include malware scanning result; and
third information 101c, to indicate current status of file(s) on a mobile storage device 50.

The scanning system 20 can be deployed in an environment where a host can be connected to internet, it is susceptible to malware and being used for creating a covert channel from the IT environment to OT environment, where the industrial control system 30 is deployed.

The monitoring system 10 can be a computer, software installed on a computer, a computer network, etc., configured to monitor secure situation of a monitored system 30, to make sure of its secure operation. It can collect logs, network flow, data (such as configuration data of a device 301 in the monitored system 30), etc. from the monitored system 30.

The scanning system 20 can send above mentioned first information 101a, second information 101b, and third information 101c to the monitoring system 10. The monitoring system 10 can store the received information for possible future security checking of a mobile storage device 50.

The information collecting module 90 can be a computer, software installed on a computer, software installed on a device 301 in the monitored system 30 having interface for connection with a mobile storage device 50, etc., configured to detect a mobile storage device 50's connection with a device 301 in the monitored system 30, and get information of the mobile storage device 50. For example, an agent or collecting script or shell can be running on a device 391 which can be used to get information of device 301 and send information to the monitoring system 10.

The collecting module 90 can acquire following fourth information 101a′ and generated following fifth information 101c′ of a device 301:
fourth information 101a′, for identification of the mobile storage device 50, which can be same with or different from the abovementioned first information 101a, as long as it can be used for identification of the mobile storage device 50.
fifth information 101c′, to indicate current status of file(s) on the mobile storage device 50. For example, the information collecting module 90 can generate the fifth information 101c′ in same way with the scanning system 20.

The information collecting module 90 can send the fourth information 101a′ and the fifth information 101c′ to the monitoring system 10. Once receiving the fourth information 101a′ and the fifth information 101b′, the monitoring system 10 can check whether the usage of the mobile storage device 50 is secure based on the above mentioned first information 101a, third information 101c, fourth information 101′, fifth information 101b′ and optional second information 101b.

The monitoring system 10 can use the fourth information 101a′ to identify a specific mobile storage device 50; and by comparing the fourth information 101a′ and stored first information 101a, to determine whether the specific mobile storage device 50 has been recorded; furthermore, if recorded, get the correlatively stored third information 101c and optional second information 101b. By comparing the third information 101c and the fifth information 101c′, the monitoring system 10 can determine whether status of file(s) on the specific mobile storage device 50 at the time of usage of the mobile storage device 50 in the monitored system 30 is same with status at the time of scanning the mobile storage device 50 by the scanning system 20. Based on result of comparison of status and optional the second information 101b, the monitoring system 10 can determine whether the usage of the mobile storage device 50 in the monitored system 30 is secure.

If the usage of the mobile storage device 50 is insecure, it can generate a warning and send alert to an administrator 40. The administrator 40 can prevent this kind of insecure usage and make further check for the monitored system 30, furthermore the administrator 40 can improve security management via training or penalty to the personnel violating security policy of usage of a mobile storage device 50.

In some embodiments, the monitoring system 10 can generate sixth information 101d and send it to the information collecting module 90, to indicate whether the usage of the mobile storage device 50 in the monitored system 30 is secure. The information collecting module 90 can process according to the sixth information 101d. For example, if usage of the specific mobile storage device 50 is insecure, the information collecting module 90 can have the mobile storage device 50 isolated from the connected device 301 in the monitored system 30 and display a warning message on the user interface of the connected device 301 which indicates that the usage of the specific mobile storage device 50 is not permitted.

The system 100 for security management of the present disclosure can further include at least one of following devices:
an update server 60
a security gateway 70
an information database 80

The scanning system 20 can update the malware library via the update server 60, which can be provided by vendor of anti-malware software via internet.

For the scanning system 20 can be deployed in an environment where a host can be connected to internet, a security gateway 70 can be used to control information transmitted from the scanning system 20 to the monitoring system 10 to mitigate risks for the monitoring system 10. Once the monitoring system 10 receives the above mentioned first information 101a, second information 101b and third information 101c, it can store the received information in the information database 80; or it can also process the received information and stored the processed information in the information database 80. Also, once receiving from the information collecting module 90 the above mentioned fourth information 101a′ and fifth information 101c′, the monitoring system 10 can retrieve above mentioned pre-stored information for security check of the mobile storage device 50.

A monitored system 30 can be an industrial control system, such as a system deployed in a factory, a traditional IT system, or any other kind of system in which a mobile storage device may be used.

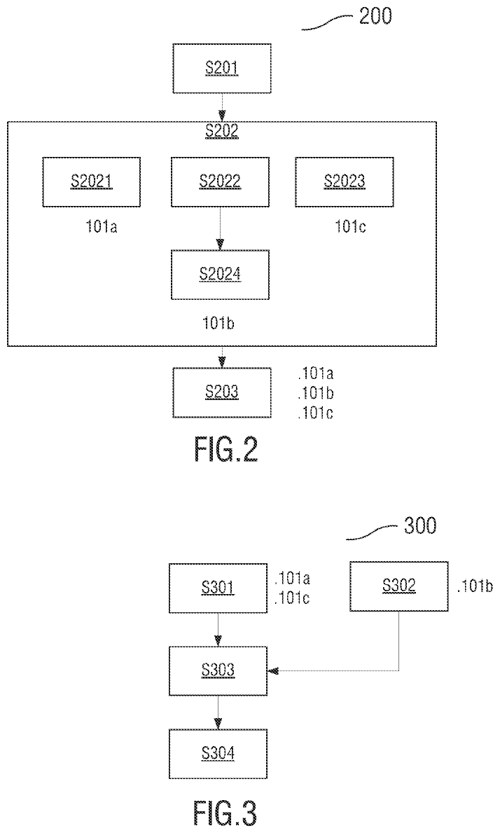

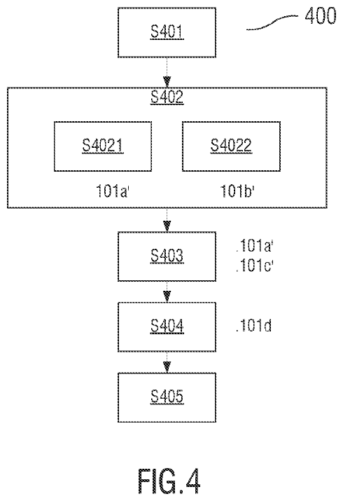

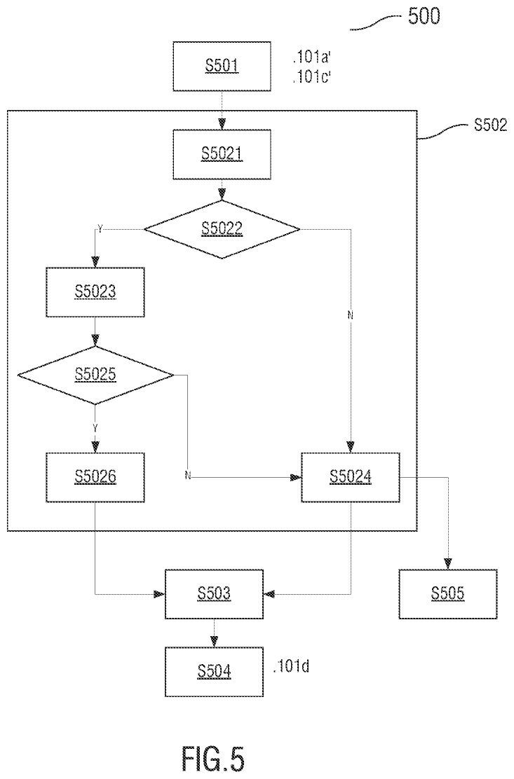

Now referring to FIG. 2, a flowchart for security management executed by a scanning system 20 incorporating teachings of the present disclosure is depicted. The method 200 can include following steps:
S201: receiving, at the scanning system. 20, a request of scanning a mobile storage device 50. In this step, the request can be sent by running an application on the scanning system 20, to scan the storage device 50 connected to the scanning system 20, optionally upon a user's command input. Or the request can be sent by another device connected to the scanning system. 20, an application running on the device can receive a user's command of scanning a mobile storage device 50.
S202: scanning and acquiring information of the mobile storage device 50 requested in the step S202, at the scanning system 20.

Step S202 can include following 3 sub steps:
S2021: acquiring, at the scanning system 20, the above mentioned first information 101a, which can be used for identification of the mobile storage device 50.
S2022: conducting a malware scanning, at the scanning system 20, on the mobile storage device 50.
S2024: generating the above mentioned second information 101b.

In sub steps S2022 and S2024, the scanning system 20 can scan the mobile storage device 50 based on the above mentioned malware library. The second information 101b can be configured to describe security status of the mobile storage device 50, to indicate whether the mobile storage device 50 is infected with virus, whether virus on the mobile storage device 50 has been cleared up, whether the mobile storage device 50 is suspicious of infecting a virus or viruses, etc.
S2023: generating, at the scanning system 20, the above mentioned third information 101c. In this sub step, the scanning system 20 can make computation based on predefined critical area (s) or file (s) or all files of the mobile storage device 50 and take the computation result as the third information 101c of the mobile storage device 50. For example, the scanning system 20 can read all files of the mobile storage device 50 and then create an authentication code with a one-way hash function, such as Secure Hash Algorithm (SHA-1) or SHA-256.
S203: sending, by the scanning system 20, the information got in the step S202 to the monitoring system 10. Optionally, if the security status indicates that the mobile storage device 50 is not infected with virus, or virus on the mobile storage device 50 has been cleared up, the scanning system 20 can only send the first information 101a and the third information 101b, without sending the second information 101b; and once the monitoring system 10 receives both information, it can determine that at the time when the scanning system 20 conducts a malware scanning on the mobile storage device 50, the mobile storage device 50 is secure to be used in the monitored system 30.

FIG. 3 depicts a flow chart for a method of security management incorporating teachings of the present disclosure and executed by a monitoring system 10 after receiving information 101a, 101b and 101c from the scanning system 20. The method 300 can include following steps:
S301: receiving, at the monitoring system 10, the first information 101a and the third information 101c.
S302: receiving, at the monitoring system 10, the second information 101b.

In some embodiments, step S302 can be omitted. As mentioned in step S203, if the security status indicates that the mobile storage device 50 is not infected with virus, or virus on the mobile storage device 50 has been cleared up, the scanning system 20 can only send the first information 101a and the third information 101b, without sending the second information 101b; and once the monitoring system 10 receives both information, it can determine that at the time when the scanning system 20 conducts a malware scanning on the mobile storage device 50, the mobile storage device 50 is secure to be used in the monitored system 30.

In some embodiments, all the first information 101a, second information 101b and third information 101c can be sent by the scanning system 20, and the monitoring system 10 can receive the three information in one message, that it the steps S301 can S302 can be combined into one step.
S303: determining, at the monitoring system 10, based on the second information 101b, whether the mobile storage device 50 can be trusted, if the mobile storage device 50 can be trusted, the monitoring system 10 proceeds with step S304, otherwise, the monitoring system can discard the first information 101a and the second information 101b.
S304: storing, at the monitoring system 10, the first information 101a and the third information 101c interrelatedly and optional the second information 101b, optionally in the information database 80.

In some embodiments, the step 303 is optional, the monitoring system 10 can directly execute the step S304 without determining whether the mobile storage device 50 can be trusted. And corresponding to embodiment that the scanning system 20 only send the first information 101a and the third information 101c, the monitoring system 10 can determine the mobile storage device 50 can be trusted, that is, it is secure to be used in the monitored system 30, and store the first information 101a and the third information 101c.

FIG. 4 depicts a flow chart for a method of security management incorporating teachings of the present disclosure and executed by the information collecting module 90 when detecting usage of a mobile storage device 50 in the monitored system 30. The method 400 can include following steps:
S401: detecting, at the information collecting module 90, a mobile storage device 50's usage in the monitored system 30.
S402: getting, at the information collecting module 90, the above mentioned fourth information 101a′ and the fifth information 101c′ of the mobile storage device 50. The step S402 can include following sub steps:
S4021: acquiring, at the information collecting module 90, the above mentioned fourth information 101a′ for identification of the mobile storage device 50.
S4022: generating, at the information collecting module 90, the above mentioned fifth information 101c′.
S403: sending the fourth information 101a′ and the fifth information 101c′ to the monitoring system 10. Upon receiving both the information, the monitoring system 20 can determine whether usage of the mobile storage device 50 is secure and send back the above mentioned sixth information 101d to the information collecting module 90.
S404: receiving, at the information collecting module 90, the sixth information 101d.
S405: processing according to the sixth information 101d. For example, if usage of the specific mobile storage device 50 is insecure, the information collecting module 90 can have the mobile storage device 50 isolated from the connected device 301 in the monitored system 30 and display a warning message on the user interface of the connected device 301 which indicates that the usage of the specific mobile storage device 50 is not permitted.

FIG. 5 depicts a flow chart for a method of security management incorporating teachings of the present disclosure and executed by the monitoring system 10 when receiving the fourth information 101a′ and the fifth information 101c′ from the information collecting module 90. The method 500 can include following steps:
S501: receiving, at the monitoring system 10, the fourth information 101a′ and the fifth information 101c′ from the information collecting module 90.
S502: checking whether the usage of the mobile storage device 50 is secure based on the above mentioned first information 101a, third information 101c, fourth information 101′, fifth information 101b′ and optional second information 101b. This step can include following sub steps:
S5021: using, at the monitoring system 10, the fourth information 101a′ to identify a specific mobile storage device 50.
S5022: comparing, at the monitoring system 10, the fourth information 101a′ and stored first information 101a, to determine whether the specific mobile storage device 50 has been recorded. If recorded, the monitoring system 10 proceeds with sub step S5023, otherwise, the monitoring system 10 proceeds with sub step S5024.
S5023: getting, at the monitoring system 10, the correlatively stored third information 101c and optional second information 101b, then the monitoring system 10 can proceed with sub step S5025.
S5024: determining, at the monitoring system 10, that the usage of the mobile storage device 50 in the monitored system 30 is insecure.

Then, the monitoring system 10 can proceed with step S505 and/or S503.
S5025: comparing, at the monitoring system 10, the third information 101c and the fifth information 101c′, to determine whether status of file(s) on the specific mobile storage device 50 at the time of usage of the mobile storage device 50 in the monitored system 30 is same with status at the time of scanning the mobile storage device 50 by the scanning system 20.

In some embodiments, in sub step S2023, the scanning system 20 reads all files of the mobile storage device 50 and then create an authentication code with SHA-256. And in sub step S4022, the information collecting module 90 also reads all files of the same mobile storage device 50, and create another authentication code with SHA-256, in same way with the scanning system 20. If the file (s) on the mobile storage device 50 is changed after being scanned by the scanning system 20, the two authentication codes cannot be the same, then the monitoring system 10 can determine that file(s) on the mobile storage device 50 has been changed after being scanned, the 2 statuses are not the same.

In some embodiments, the scanning system 20 records time of scanning the mobile storage device 50, and takes it as the third information 101c, the time can be the beginning or ending time of scanning, or any time during scanning. And the information collecting module 90 records time of detecting the mobile storage device 50 to be connected with a device 301 in the monitored system 30 or the time of sending the fifth information 101c′, or any time in between, and takes it as the fifth information 101c′. The monitoring system can calculate duration between the two times indicated respectively by the third information 101c and the fifth information 101c′, if the duration is longer than a predefined threshold, the monitoring system 10 can determine that the 2 statuses are not the same; otherwise, the monitoring system 10 can determine that the 2 statuses are the same.

If the 2 statues are the same, the monitoring system 10 can proceed with sub step S5026; otherwise, the monitoring system 10 can proceed with sub step S5024.
S5026: determining, at the monitoring system 10, that the usage of the mobile storage device 50 in the monitored system 30 is secure. Then, the monitoring system 10 can proceed with step S503.
S503: generating, at the monitoring system 10, the above mentioned sixth information 101d to indicate whether the usage of the mobile storage device 50 in the monitored system 30 is secure. Then the monitoring system 10 can proceed with step S504.
S504: sending, by the monitoring system 10, the sixth information 101d to the information collecting module 90.
S505: generating, at the monitoring system 10, a warning and sending alert to an administrator 40. Then the administrator 40 can prevent this kind of insecure usage and make further check for the monitored system 30, furthermore the administrator 40 can improve security management via training or penalty to the personnel violating security policy of usage of a mobile storage device.

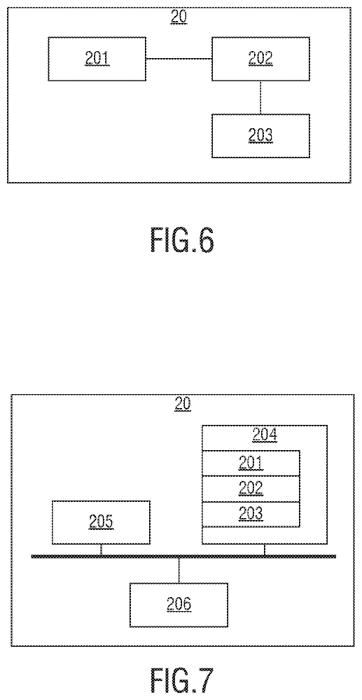

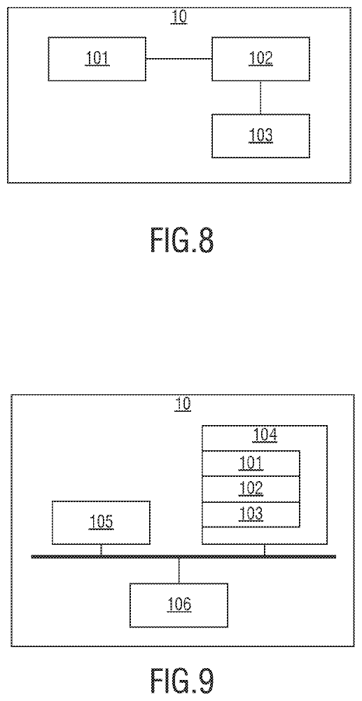

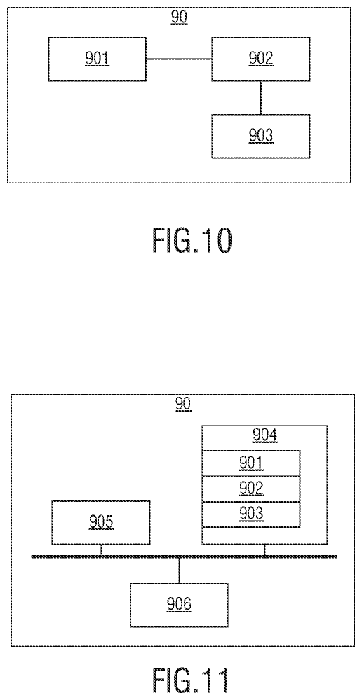

FIG. 6 depicts a block diagram displaying an exemplary embodiment of a scanning system 20 incorporating teachings of the present disclosure. Referring to FIG. 6, the scanning system 20 can include:
an acquisition module 201, configured to acquire first information 101a for identification of a mobile storage device 50;
a generation module 202, configured to generate third information 101c to indicate current status of files on the mobile storage device 50;
a sending module 203, configured to send the first information 101a and the third information 101c to a monitoring system 10, for the monitoring system 10 to check if usage of the mobile storage device 50 in the monitored system 30 is secure.

In some embodiments, the acquisition module 201 is further configured to conduct a malware scanning on the mobile storage device 50; the generation module 202 is further configured to generate second information 101b to describe security status of the mobile storage device 50; and the sending module 203 is further configured to send the second information 101b to the monitoring system 10.

In some embodiments, the acquisition module 201 is further configured to conduct a malware scanning on the mobile storage device 50; the generation module 202 is further configured to generate second information 101b to describe security status of the mobile storage device 50; and the sending module 203 is further configured to send the first information 101a and the third information 102c to the monitoring system. 10, only if the second information 101b indicates that the mobile storage device 50 can be trusted.

In some embodiments, when generating the third information 101c, the generation module 202 is further configured to: make computation based on predefined at least one file and/or at least one area of the mobile storage device 50; and take the computation result as the third information 101c.

In some embodiments, when generating the third information 101c, the generation module 202 is further configured to: record time of scanning the mobile storage device 50 as the third information 101c.

FIG. 7 depicts another block diagram displaying an exemplary embodiment of a scanning system 20 incorporating teachings of the present disclosure. Referring to FIG. 7, the scanning system. 20 can include:
at least one memory 204, configured to store instructions;
at least one processor 205, coupled to the at least one memory 204, and upon execution of the executable instructions, configured to execute the steps executed by the scanning system 20 according to method 200.

In some embodiments, the scanning system 20 may also include a communication module 206, configured to transmit data, indications etc. to the monitoring system 10 and optionally, update malware with the update server 60. The at least one processor 205, the at least one memory 204 and the communication module 206 can be connected via a bus or connected directly to each other.

In some embodiments, the above mentioned modules 201˜203 can be software modules including instructions which are stored in the at least one memory 204, when executed by the at least one processor 205, execute the method 200.

FIG. 8 depicts a block diagram displaying an exemplary embodiment of a monitoring system 10 incorporating teachings of the present disclosure. Referring to FIG. 8, the monitoring system 10 may include:
a receiving module 101, configured to receive from a scanning system 20 first information 101a for identification of a mobile storage device 50 and third information 101c to indicate current status of files on the mobile storage device 50;
a processing module 102, configured to store the first information 101a and the third information 101c correlatively;
the receiving module 101, further configured to receive from an information collecting module 90 fourth information 101a′ for identification of the mobile storage device 50 and fifth information 101c′ to indicate current status of files on the mobile storage device 50;
the processing module 102, further configured to compare the fourth information 101a′ and stored first information 101a, to determine whether the mobile storage device 50 has been recorded; if recorded, get the correlatively stored third information 101c; compare the third information 101c and the fifth information 101c′ to determine whether the two statuses indicated respectively by the third information 101c and the fifth information 101c′ are the same; if the two statuses are the same, determine that the usage of the mobile storage device 50 in the monitored system 30 is secure.

In some embodiments, the receiving module 101 is further configured to receive from a scanning system 20 second information 101b to describe security status of the mobile storage device 50; the processing module 102 is further configured to determine based on the second information 101b whether the mobile storage device 50 can be trusted; if the mobile storage device 50 can be trusted, store correlatively the first information 101a and the third information 101c.

In some embodiments, the processing module 102 is further configured to determine that the usage of the mobile storage device 50 in the monitored system 30 is insecure if the mobile storage device 50 hasn't been recorded.

In some embodiments, the processing module 102 is further configured to generate sixth information 101d to indicate whether the usage of the mobile storage device 50 in the monitored system 30 is secure; and the monitoring system 10 further comprises a sending module 103, configured to send the sixth information 101d to the information collecting module 90.

FIG. 9 depicts a block diagram displaying another exemplary embodiment of a monitoring system incorporating teachings of the present disclosure. Referring to FIG. 9, the monitoring system 10 may include:
at least one memory 104, configured to store executable instructions;
at least one processor 105, coupled to the at least one memory 104 and upon execution of the executable instructions, configured to execute method 300 and/or 500.

In some embodiments, the monitoring system 10 may also include a communication module 106, configured to receive from the scanning system 20, receive and send information to the information collecting module 90. The at least one processor 105, the at least one memory 104 and the communication module 106 can be connected via a bus, or connected directly to each other.

In some embodiments, the above mentioned modules 101˜103 can be software modules including instructions which are stored in the at least one memory 104, when executed by the at least one processor 105, execute the method 300 and 500.

FIG. 10 depicts a block diagram displaying an exemplary embodiment of an information collecting module 90 incorporating teachings of the present disclosure. Referring to FIG. 10, the information collecting module 90 can include:
a detecting module 901, configured to detect a mobile storage device 50's usage in a monitored system 30;
a processing module 902, configured to get fourth information 101a′ for identification of the mobile storage device 50 and fifth information 101c′ to indicate current status of files on the mobile storage device 50;
a sending module 903, configured to send the fourth information 101a′ and the fifth information 101c′ to the monitoring system 10, for the monitoring system 10 to check if usage of the mobile storage device 50 in a monitored system 30 is secure.

In some embodiments, the detecting module 901 is further configured to receive from the monitoring system 10 the sixth information 101d; and the processing module is further configured to isolate the mobile storage device 50 from the monitored system 30 if the sixth information 101d indicates that usage of the mobile storage device 50 in the monitored system 30 in insecure.

FIG. 11 depicts a block diagram displaying another exemplary embodiment of an information collecting module 90 incorporating teachings of the present disclosure. Referring to FIG. 11, the information collecting module 90 can include:
at least one memory 904, configured to store executable instructions;
at least one processor 905, coupled to the at least one memory 904 and upon execution of the executable instructions, configured to execute method 400.

In some embodiments, the information collecting module 90 may also include a communication module 906, configured to communicate with the monitoring system 10. The at least one processor 905, the at least one memory 904 and the communication module 906 can be connected via a bus, or connected directly to each other.

In some embodiments, the above mentioned modules 901903 can be software modules including instructions which are stored in the at least one memory 904, when executed by the at least one processor 905, execute the method 400.

With the teachings described herein, a scanning system can send information of the status of files on a mobile storage device at time of scanning to a monitoring system, and an information collecting module can also send information of status of files on the mobile storage device at time of detecting usage of the mobile storage device in a monitored system to the monitoring system. The monitoring system then can determine whether files on the mobile storage device are changed after scanning, to make sure of secure usage of the mobile storage device in the monitored system. With both the scanning system and the monitoring system installed outside the monitored system, possibility of information of the status of files on the mobile storage device being tampered with by attacks towards the monitored system. With cooperation of the mobile system and the information collecting module, usage of the mobile storage device in the monitored system can be detected in the first place, viruses can be isolated before affecting the monitored system.

A computer-readable medium storing executable instructions, which upon execution by a computer, enables the computer to execute any of the methods presented in this disclosure. A computer program, executed by at least one processor and performing any of the methods presented in this disclosure.

While the present technique has been described in detail with reference to certain embodiments, it should be appreciated that the present technique is not limited to those precise embodiments. Rather, in view of the present disclosure which describes exemplary modes for practicing the teachings herein, many modifications and variations would present themselves, to those skilled in the art without departing from the scope and spirit of this disclosure. All changes, modifications, and variations coming within the meaning and range of equivalency of the claims are to be considered within their scope.

### REFERENCE NUMBERS

100, a system for security management
10, a monitoring system
20, a scanning system
30, a monitored system
301, a device in the monitored system 30, which a mobile storage
device may be connected to
40, administrator
50, a mobile storage device
60, an update server
70, a security gateway
80, an information database
90, an information collecting module
101a, first information, acquired by the scanning system 20, for identification of a mobile storage device 50
101b, second information, generated by the scanning system 20 during malware scanning of the mobile storage device 50, describing security status of the mobile storage device 50
101c, third information, generated by the scanning system 20, to indicate current status of file(s) on a mobile storage device 50
101a′, fourth information, acquired by the information collecting module 90 when detecting usage of a mobile storage device 50 in the monitored system 30, for identification of the mobile storage device 50
101c′, fifth information, generated by the information collecting module 90, when detecting usage of the mobile storage device 50 in the monitored system 30, to indicate current status of file(s) on the mobile storage device 50
101d, sixth information, generated by the monitoring system 10 and sent to the information collecting module 90, to indicate whether the usage of a mobile storage device 50 in the monitored system 30 is secure
200, 300, 400, 500, methods for security management
S201˜S203, S301˜S303, S401˜404, S501˜S506, steps of flow charts for security management of the present disclosure
201˜203, modules of scanning system 20
204, memory
205, processor
206, communication module
101˜103, modules of monitoring system 10
104, memory
105, processor
106, communication module
901˜903, modules of information collecting module 90
904, memory
905, processor
906, communication module

1. A system for security management on usage of a mobile storage device in a monitored system, the system comprising:
a scanning system installed outside the monitored system the scanning system is configured to acquire first information for identification of the motile storage device and generate third information to indicate current status of files on the mobile storage device and send the first information and the third information to a monitoring system;
the monitoring system installed outside the monitored system, the monitoring system is configured to receive the first information and the third information from the scanning system and store the first information and the third information correlatively, and
an information collecting module configured to:
detect the mobile storage device's usage in a monitored system,
get fourth information for identification of the mobile storage device and fifth information to indicate current status of files on the mobile storage device, and
send the fourth information and the fifth information to the monitoring system;
wherein the monitoring system is further configured to:
receive the fourth information and the fifth information from the information collecting module,
use the fourth information to identify the mobile storage device,
compare the fourth information and stored first information to determine whether the mobile storage device has been recorded,
if recorded, get the correlatively stored third information and compare the third information and the fifth information, to determine whether the two statuses indicated respectively by the third information and the fifth information are the same; and
if the two statuses are the same, determine that the usage of the mobile storage device in the monitored system is secure.

2. The system according to claim 1, wherein
the scanning system is further configured to:
conduct a malware scanning on the mobile storage device;
generate second information to describe security status of the mobile storage device; and
send the second information to the monitoring system;
the monitoring system is further configured to:
receive the second information from the scanning system;
determine, based on the second information, whether the mobile storage device can be trusted; and
if the mobile storage device can be trusted, store correlatively the first information and the third information.

3. The system according to claim 1, wherein the scanning system is further configured to:
conduct a malware scanning on the mobile storage device;
generate second information to describe security status of the mobile storage device; and
only if the second information indicates that the mobile storage device can be trusted, send the first information and the third information to the monitoring system.

4. The system according to claim 1, wherein the monitoring system is further configured to,
if the mobile storage device hasn't been recorded, determine that the usage of the mobile storage device in the monitored system is insecure.

5. The system, according to claim 1, wherein the monitoring system is further configured to:
generate sixth information to indicate whether the usage of the mobile storage device in the monitored system is secure; and
send the sixth information to the information collecting module;
the information collecting is further configured to:
receive the sixth information from the monitoring system;
if the sixth information indicates that usage of the mobile storage device in the monitored system in insecure, isolate the mobile storage device from the monitored system.

6. The system according to claim 1, wherein when generating the third information, the scanning system is further configured to:
make computation based on predefined at least one file and/or at least one area of the mobile storage device; and
take the computation result as the third information;
when getting the fifth information, the information collecting module is further configured to
generate the fifth information in the same way that the third information is calculated;
when determining whether the two statuses indicated respectively by the third information and the fifth information are the same, the monitoring system is further configured to
if the two calculation results indicated respectively by the third information and the fifth information are the same, determine that the two statuses are the same, otherwise, determine that the two statuses are different.

7. The system according to claim 1, wherein:
when generating the third information, the scanning system is further configured to
record time of scanning the mobile storage device as the third information;
when getting the fifth information, the information collecting module is further configured to
record time of detecting the mobile storage device to be connected to a device in the monitored system as fifth information;
when determining whether the two statuses indicated respectively by the third information and the fifth information are the same, the monitoring system is further configured to
if duration between the two times indicated respectively by the third information and the fifth information is not longer than a predefined threshold, determine that the two statuses are the same; otherwise, determine that the two statuses are different.

8. The system according to claim 1, further comprising a security gateway between the scanning system and the monitoring system.

9. A method for security management at a scanning system installed outside a monitored system, the method comprising:
acquiring first information for identification of a mobile storage device;
generating third information to indicate current status of files on the mobile storage device; and
sending the first information and the third information to a monitoring system to check if usage of the mobile storage device in the monitored system is secure.

10. The method according to claim 9, further comprising:
conducting a malware scanning on the mobile storage device;
generating second information to describe security status of the mobile storage device;
sending, the second information to the monitoring system.

11. The method according to claim 9, further comprising:
conducting a malware scanning on the mobile storage device;
generating second information to describe security status of the mobile storage device;
only if the second information indicates that the mobile storage device can be trusted, sending the first information and the third information to the monitoring system.

12. The method according to claim 9, wherein generating the third information the scanning system comprises:
making computation based on predefined at least one file and/or at least one area of the mobile storage device and
taking the computation result as the third information.

13. The method according to claim 9, wherein generating the third information comprises
recording time of scanning the mobile storage device as the third information.

14. A method for security management at a monitoring system installed outside a monitored system, the comprising:
receiving from a scanning system first information for identification of a mobile storage device and third information to indicate current status of files on the mobile storage device;
storing the first information and the third information correlatively;
receiving from an information collecting module fourth information for identification of the mobile storage device and fifth information to indicate current status of files on the mobile storage device;
comparing the fourth information and stored first information to determine whether the mobile storage device has been recorded;
if recorded, getting the correlatively stored third information, comparing the third information and the fifth information to determine whether the two statuses indicated respectively by the third information and the fifth information are the same; and
if the two statuses are the same, determining that the usage of the mobile storage device in the monitored system is secure.

15. The method according to claim 14, further comprising:
receiving from a scanning system second information to describe security status of the mobile storage device;
determining, based on the second information, whether the mobile storage device can be trusted; and
if the mobile storage device can be trusted, storing correlatively the first information and the third information.

16. The method according to claim 14, further comprising,
if the mobile storage device hasn't been recorded, determining that the usage of the mobile storage device in the monitored system is insecure.

17. The method according to claim 14, further comprising:
generating sixth information to indicate whether the usage of the mobile storage device in the monitored system is secure; and
sending the sixth information to the information collecting module.

18. A method for security management at an information collecting module, the method comprising:
detecting a mobile storage device's usage in a monitored system;
getting fourth information for identification of the mobile storage device and fifth information to indicate current status of files on the mobile storage device;
sending the fourth information and the fifth information to a monitoring system to check if usage of the mobile storage device in a monitored system is secure.

19. The method according to claim 18, further comprising:
receiving from the monitoring system sixth information; and
if the sixth information indicates that usage of the mobile storage device in the monitored system is insecure, isolating the mobile storage device from the monitored system.

20. A scanning system installed outside a monitored system, the system comprising:
an acquisition module configured to acquire first information for identification of a mobile storage device;
a generation module configured to generate third information to indicate current status of files on the mobile storage device; and
a sending module configured to send the first information and the third information to a monitoring system, for the monitoring system to check if usage of the mobile storage device (50) in the monitored system is secure.

21. The scanning system according to claim 20, wherein:
the acquisition module is further configured to conduct a malware scanning on the mobile storage device;
the generation module is further configured to generate second information to describe security status of the mobile storage device; and
the sending module is further configured to send the second information to the monitoring system.

22. The scanning system according to claim 20, wherein:
the acquisition module is further configured to conduct a malware scanning on the mobile storage device;
the generation module is further configured to generate second information to describe security status of the mobile storage device;
the sending module is further configured to send the first information and the third information to the monitoring system, only if the second information indicates that the mobile storage device can be trusted.

23. The scanning system according to claim 20, wherein when generating the third information, the generation module is further configured to:
make computation based on predefined at least one file and/or at least one area of the mobile storage device; and
take the computation result as the third information.

24. The scanning system according to claim 20, wherein when generating the third information, the generation module is further configured to
record time of scanning the mobile storage device as the third information.

25. A monitoring system installed outside a monitored system; the monitoring system comprising:
a receiving module configured to receive from a scanning system first information for identification of a mobile storage device and third information to indicate current status of files on the mobile storage device;
a processing module configured to store the first information and the third information correlatively;
the receiving module further configured to receive from an information collecting module fourth information for identification of the mobile storage device and fifth information to indicate current status of files on the mobile storage device;
the processing module further configured to:
compare the fourth information and stored first information, to determine whether the mobile storage device has been recorded;
if recorded, get the correlatively stored third information;
compare the third information and the fifth information to determine whether the two statuses indicated respectively by the third information and the fifth information are the same; and
if the two statuses are the same, determine that the usage of the mobile storage device in the monitored system is secure.

26. The monitoring system according to claim 25, wherein
the receiving module is further configured to receive from a scanning system second information to describe security status of the mobile storage device;
the processing module is further configured to determine based on the second information whether the mobile storage device can be trusted; and
if the mobile storage device can be trusted, store correlatively the first information and the third information.

27. The monitoring system according to claim 25, wherein the processing module is further configured to determine that the usage of the mobile storage device in the monitored system is insecure if the mobile storage device hasn't been recorded.

28. The monitoring system according to claim 25, wherein
the processing module is further configured to generate sixth information to indicate whether the usage of the mobile storage device in the monitored system is secure;
the monitoring system further comprises a sending module configured to send the sixth information to the information collecting module.

29. An information collecting module comprising:
a detecting module configured to detect a mobile storage device usage in a monitored system;
a processing module configured to get fourth information for identification of the mobile storage device and fifth information to indicate current status of files on the mobile storage device; and
a sending module configured to send the fourth information and the fifth information to the monitoring system to check whether usage of the mobile storage device in a monitored system is secure.

30. The information collecting module according to claim 29, wherein:
the detecting module is further configured to receive from the monitoring system the sixth information; and
the processing module is further configured to isolate the mobile storage device from the monitored system if the sixth information indicates that usage of the mobile storage device in the monitored system is insecure.

31-34. (canceled)
